(19) United States
(12) Patent Application Publication
(10) Pub. No.: US 2026/0299186 A1
(43) Pub. Date: Oct. 1, 2026

(54) DISPLAY DEVICE

(71) Applicant: LG Display Co., Ltd., Seoul (KR)

(72) Inventors: Youngmin KWON, Paju-si (KR); Taemin LIM, Paju-si (KR)

(21) Appl. No.: 19/480,423

(22) PCT Filed: Jan. 24, 2025
(86) PCT No.: PCT/KR2025/001482

§ 371 Date: Oct. 31, 2025

(30) Foreign Application Priority Data
Feb. 22, 2024 (KR) 10-2024-0025895

(51) Int. Cl. F21V 8/00

(52) U.S. Cl. CPC G02B 6/0068

(57) ABSTRACT

A display device according to one embodiment of the present specification includes a first light source unit including a plurality of first light sources; a light controller which is disposed on the first light source unit and includes a plurality of partitions overlapping at least a partial area of the active area; a second light source unit which is disposed on the light controller and includes a plurality of second light sources; a light guide plate which is disposed to be parallel to the second light source unit and guides light provided from the second light source unit; and a display panel which is disposed on the light guide plate and displays an image using light provided from the first light source unit or the second light source unit, and the plurality of partitions may have a different height in each area.

### CROSS REFERENCE TO RELATED APPLICATION

This application is a National Stage Entry of International Patent Application No. PCT/KR2025/001482, filed on Jan. 24, 2025, which claims priority from and the benefit of Korean Patent Application No. 10-2024-0025895, filed on Feb. 22, 2024, which is hereby incorporated by reference for all purposes as if fully set forth herein.

### BACKGROUND

### Field

Embodiments of the invention relate generally to a display device, and more particularly, to a display device in which a viewing angle is controllable.

### Discussion of the Background

As the technology in modern society develops, display devices are used in various ways to provide information to users. The display devices include not only electronic signs which simply transmit visual information in one direction, but also various electronic devices which require a higher level of technology to check user's input and provide information in response to the checked input.

For example, a display device is included in a vehicle to provide various information to a driver and a passenger of the vehicle. However, the display device for the vehicle needs to appropriately display contents without interrupting the operation of the vehicle. For example, the display device needs to limit the display of the contents which may reduce the concentration on driving while the vehicle is in operation.

The above information disclosed in this Background section is only for understanding of the background of the inventive concepts, and, therefore, it may contain information that does not constitute prior art.

### SUMMARY

Display devices according to embodiments of the invention are capable of providing contents in a first area of an active area at a wide viewing angle and providing contents in a second area at a wide viewing angle or a narrow viewing angle according to a driving mode.

Display devices according to embodiments of the invention are also capable of providing a display device in which, in a second mode in which contents are provided at a narrow viewing angle in a second area, an image displayed in the second area is not visible to a user who is located in the first area to effectively control the viewing angle in the second mode.

Display devices according to embodiments of the invention are also capable of providing a display device which minimizes a boundary visibility between a first area and a second area of a display panel.

Additional features of the inventive concepts will be set forth in the description which follows, and in part will be apparent from the description, or may be learned by practice of the inventive concepts.

According to one or more embodiments of the invention, a display device includes a first light source unit including a plurality of first light sources; a light controller disposed on the first light source unit and including a plurality of partitions overlapping at least a partial area of the active area; a second light source unit disposed on the light controller and including a plurality of second light sources; a light guide plate disposed parallel to the second light source unit and configured to guide light provided from the second light source unit; and a display panel disposed on the light guide plate and configured to display an image using light provided from the first light source unit or the second light source unit. The plurality of partitions may have a different height in each area.

The active area may include a first area in which an image is disposed at a first viewing angle in a first mode and a second mode and a second area in which an image is displayed at the first viewing angle in the first mode and an image is displayed at a second viewing angle which is smaller than the first viewing angle in the second mode.

Heights of the plurality of partitions may be decreased from the second area toward the first area.

The plurality of partitions may include a plurality of first partitions having a first height and which are disposed on a first sub area, which is a partial area of the first area; a plurality of second partitions having a second height greater than the first height, which are disposed on a second sub area, which is a partial area of the second area; and a plurality of third partitions disposed on a third sub area between the first sub area and the second sub area, and having a height between the first height and the second height.

A height of each of the plurality of third partitions may be decreased from the second sub area toward the first sub area.

The third sub area may include a boundary line between the first area and the second area.

Each of the plurality of partitions may have a quadrangular columnar shape.

Each of the plurality of partitions may have a rectangular or trapezoidal side surface.

A center axis of each of the plurality of partitions may be inclined from a direction perpendicular to the active area.

According to yet another embodiment of the invention, a display device includes a cover; a first light source unit disposed on a bottom portion of the cover and including a plurality of first light sources; an optical sheet disposed on the first light source unit and having one end supported by a first side portion of the cover and the other end supported by a second side portion of the cover; a first fixing member disposed above one end of the optical sheet; a second fixing member disposed above the other end of the optical sheet; a light controller disposed on the optical sheet and having one end supported by the first fixing member and the other end supported by the second fixing member, and including a plurality of partitions which overlap at least a partial area of the active area; a light guide plate disposed on the light controller and having one end supported by a third side portion of the cover and the other end supported by a fourth side portion of the cover; a second light source unit disposed to be parallel to the light guide plate and including a plurality of second light sources; and a display panel disposed on the light guide plate and configured to display an image using light provided from the first light source unit or the second light source unit.

A height of the first fixing member may be different from and a height of the second fixing member.

The first side portion and the second side portion may be disposed on the same plane; the third side portion may be disposed on the first side portion; and the fourth side portion may be disposed on the second side portion and may be disposed on the same plane as the third side portion.

The light controller may be inclined from a direction parallel to the active area.

According to yet another embodiment of the invention, a display device includes a cover; a first light source unit disposed on a bottom portion of the cover and including a plurality of first light sources; an optical sheet disposed on the first light source unit and having one end supported by a first side portion of the cover and the other end supported by a second side portion of the cover; a light controller disposed on the optical sheet and including a plurality of partitions overlapping at least a partial area of an active area; a light guide plate which is disposed on the light controller and has one end supported by a third side portion of the cover and the other end supported by a fourth side portion of the cover; a second light source unit disposed to be parallel to the light guide plate and including a plurality of second light sources; and a display panel disposed on the light guide plate and configured to display an image using light provided from the first light source unit or the second light source unit. A height from the bottom to a top surface of the first side portion may be different from a height from the bottom to the second side portion.

The light controller may be inclined from a direction parallel to the active area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a view of a display device according to an embodiment of the invention.

FIG. 2 is an exploded perspective view of a display device according to an embodiment of the invention.

FIG. 3 is a view illustrating an example of a display panel included in a display device according to an embodiment of the invention.

FIG. 4 is a side view schematically illustrating an example of a light controller included in a display device of FIG. 2.

FIG. 5A is an enlarged view illustrating an example of a part EA1 of FIG. 4.

FIG. 5B is an enlarged view illustrating an example of a part EA2 of FIG. 4.

FIG. 5C is an enlarged view illustrating an example of a part EA3 of FIG. 4.

FIG. 6 is a side view schematically illustrating another example of a light controller included in a display device of FIG. 2.

FIG. 7A is an enlarged view illustrating an example of a part EA4 of FIG. 6.

FIG. 7B is an enlarged view illustrating an example of a part EA5 of FIG. 6.

FIG. 8 is a side view schematically illustrating still another example of a light controller included in a display device of FIG. 2.

FIG. 9 is an enlarged view illustrating an example of a part EA6 of FIG. 8.

FIG. 10 is a side view schematically illustrating still another example of a light controller included in a display device of FIG. 2.

FIG. 11 is a side view of a display device according to another embodiment of the invention.

FIG. 12 is a side view illustrating an example of a light controller included in a display device of FIG. 11.

FIG. 13 is a side view of a display device according to still another embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,”“ ” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software.

It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a display apparatus according to embodiments of the invention will be described in detail with reference to accompanying drawings.

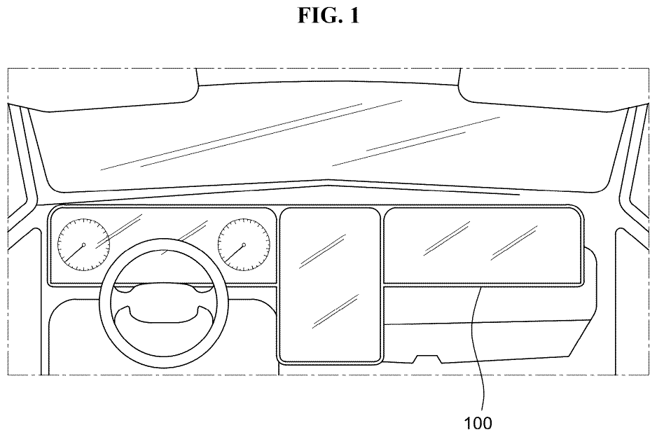

FIG. 1 is a view of a display device according to embodiment of the invention.

Referring to FIG. 1, the display device 100 may be disposed in at least a part of a dashboard of a vehicle. The dashboard of the vehicle may include a configuration disposed in a front surface of front seats (for example, a driver seat and a front passenger seat) of the vehicle. For example, on the dashboard of the vehicle, an input configuration for manipulating various functions (for example, an air-conditioner, an audio system, or a navigation system) in the vehicle is disposed.

The display device 100 is disposed on the dashboard of the vehicle to operate as an input unit which manipulates at least a part of various functions of the vehicle. The display device 100 may provide various pieces of information related to the vehicle, for example, operation information of the vehicle (for example, a current speed of the vehicle, a remaining fuel amount, or a mileage) or information about parts of the vehicle (for example, a damage level of a vehicle tire).

The display device 100 may be disposed across the driver seat and the front passenger seat disposed in the front seats of the vehicle. A user of the display device 100 may include a driver of the vehicle and a passenger riding on the front passenger seat. Both the vehicle driver and the passenger may use the display device 100.

Only a part of the display device 100 may be illustrated in FIG. 1. The display device 100 illustrated in FIG. 1 may represent a display panel, among various configurations included in the display device 100. Specifically, for example, the display device 100 illustrated in FIG. 1 may represent at least a part of an active area and a non-active area of the display panel. Among the configurations of the display device 100, configurations other than the parts illustrated in FIG. 1 may be mounted inside the vehicle (or at least a part of the inside of the vehicle).

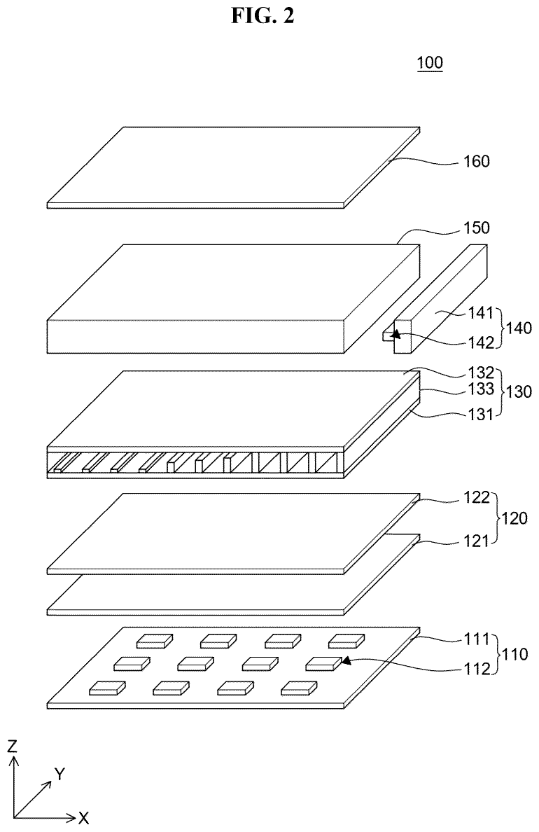

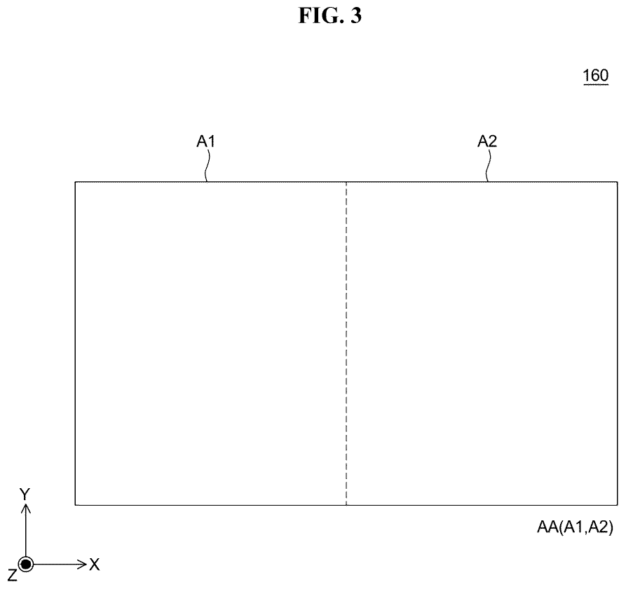

FIG. 2 is an exploded perspective view of a display device according to embodiment of the invention. FIG. 3 is a view illustrating an example of a display panel of a display device according to an embodiment of the invention.

In the meantime, for the convenience of description, hereinafter, a horizontal direction on the plain is illustrated as a first direction X and a vertical direction on the plane is illustrated as a second direction Y. Further, a normal direction of a plane defined by the first direction X and the second direction Y, for example, a thickness direction of the display device 100 may be defined as a third direction Z.

Referring to FIG. 2, the display device 100 may include a first light source unit 110, at least one optical sheet 120, a light controller 130, a second light source unit 140, a light guide plate 150, and a display panel 160.

The display panel 160 may generate an image to be provided to a user using light provided from a light source unit disposed therebelow. For example, the display panel 160 adjusts a transmittance for light provided from the first light source unit 110 and/or the second light source unit 140 disposed therebelow to display an image.

As the display panel 160, a liquid crystal display panel may be applied. For example, the display panel 160 may include a bottom substrate, a top substrate which is opposite to the bottom substrate, and a liquid crystal layer disposed between the bottom substrate and the top substrate. Here, the liquid crystal layer may be driven by a vertical field driving method, such as a twisted nematic (TN) mode and a vertical alignment (VA) mode, or a horizontal field driving method, such as an in-plane switching (IPS) mode and a fringe field switching (FFS) mode, but is not limited thereto.

The display panel 160 may include an active area in which an image is displayed and a non-active area which encloses the active area.

The active area of the display panel 160 may be partitioned into a plurality of areas. In other words, the active area may include a plurality of areas.

For example, further referring to FIG. 3, the active area AA of the display panel 160 may include a plurality of areas disposed along the first direction X. For example, the active area AA may include a first area A1 and a second area A2, which is adjacent to the first area A1, in the first direction X.

According to this embodiment, the first area A1 and the second area A2 of the display panel 160 are disposed across a driver seat and a front passenger seat disposed in front seats of the vehicle which have been described with reference to FIG. 1 to provide various bits of information to a driver and a passenger of the vehicle. Each of the first area A1 and the second area A2 of the display panel 160 may display different information images to the user. For example, the first area A1 of the display panel 160 includes an area provided to the driver seat disposed on the front seat of the vehicle and/or an area provided between the driver seat and the front passenger seat, for example, a CID area to provide information such as a driving speed, RPM, an engine temperature, and a fuel amount. The second area A2 of the display panel 160 includes an area provided to the front passenger seat disposed on the front seat of the vehicle, for example, a CDD area to provide entertainment functions and seat information for the passenger sitting in the front passenger seat. However, such area division is for the convenience of description and the first area A1 and the second area A2 in the display panel 160 may be defined in various ways depending on the design.

In the meantime, when the display panel 160 is used for the vehicle which has been described with reference to FIG. 1, a field of view of at least a partial area of the display panel 160 needs to be restricted according to the user's request. For example, images displayed in the second area A2 which provides the entertainment function and the seat information for the passenger sitting on the front passenger seat may interrupt the driving of the driver.

Accordingly, according to the user's request, the field of view of the image displayed in the second area A2 needs to be restricted.

For example, according to the driving mode of the display device 100, in the first mode, both the first area A1 and the second area A2 of the display panel 160 are controlled in a wide field-of-view mode (share mode) to display an image. In the second mode, at least a part of the display panel 160, for example, the second area A2 is controlled in a narrow field-of-view mode (private mode) to display an image. To this end, the display device 100 controls whether to allow the second light source unit 140 disposed on the top, among the plurality of light source units disposed below the display panel 160, to emit light to control the display panel 160 in the first mode or the second mode.

Referring to FIG. 2, a first light source unit 110, at least one optical sheet 120, a light controller 130, a second light source unit 140, and a light guide plate 150 may be disposed below the display panel 160.

The first light source unit 110 may generate light and provide the generated light to the third direction Z, for example, toward the optical sheet 120. The first light source unit 110 may be disposed below the optical sheet 120. For example, the first light source unit 110 may be a direct type backlight assembly.

The first light source unit 110 may include a first circuit board 111 and a plurality of first light sources 112 disposed on the first circuit board 111.

The first circuit board 111 may include a driving circuit which drives the plurality of light sources 112. The driving circuit of the first circuit board 111 may generate an electrical signal to drive the plurality of first light sources 112 and supply the electrical signal to the plurality of first light sources 112. However, the inventive concepts are not limited thereto and the driving circuit may be disposed at the outside of the first circuit board 111.

The plurality of first light sources 112 may be mounted on the first circuit board 111. For example, the plurality of first light sources 112 are disposed on the first circuit board 111 to be spaced apart from each other along the first direction X and the second direction Y to be mounted on a top surface which is one surface of the first circuit board 111. For example, the plurality of first light sources 112 are disposed on the first circuit board 111 in a matrix to be mounted, but are not limited thereto.

Each of the plurality of first light sources 112 may be formed to emit white light, but are not limited thereto, and each of the plurality of first light sources 112 may be formed to emit light with any one wavelength of red, green, and blue.

As the plurality of first light sources 112, a light emission diode (LED), a cold cathode fluorescent lamp (CCFL), or an external electrode fluorescent lamp may be used, but the inventive concepts are not limited thereto.

At least one optical sheet 120 may be disposed on the first light source unit 110. On the first light source unit 110, a plurality of optical sheets which diffuses or condenses light incident from the first light source unit 110 may be included.

For example, the optical sheet 120 may include a first optical sheet 121 and a second optical sheet 122. The first optical sheet 121 may diffuse light provided from the first light source unit 110 and allow light to travel upwardly, for example, in the third direction Z. For example, the first optical sheet 121 may be a diffusion sheet. The second optical sheet 122 condenses light which has passed through the first optical sheet 121 to allow light to travel upwardly, for example, in the third direction Z. For example, the second optical sheet 122 may be a prism sheet.

However, the inventive concepts are not limited thereto, and the optical sheet 120 may further include another optical sheet, in addition to the first optical sheet 121 and the second optical sheet 122. For example, the optical sheet 120 may further include a luminance improvement sheet, such as a protective sheet or a dual brightness enhancement film, or include a composite optical sheet in which the diffusion sheet and the prism sheet are integrated, instead of the first optical sheet 121 and the second optical sheet 122.

The light controller 130 may be disposed on the optical sheet 120.

The light controller 130 may control a viewing angle of light provided from the bottom. For example, the light controller 130 may restrict a viewing angle or an emission angle in the first direction X, of light which is emitted from the first light source unit 110 to pass through the optical sheet 120 and travel in a third direction Z which is perpendicular to the active area AA. That is, the light controller 130 may reduce or narrow a profile of light which is emitted from the first light source unit 110 to be incident into the light controller 130, in the first direction X. In this case, a viewing angle of an image which is displayed by the light in the first direction X may be reduced.

To this end, the light controller 130 may include a first support member 131, a second support member 132 which is opposite to the first support member 131, and a plurality of partitions 133 which is disposed between the first support member 131 and the second support member 132. In the meantime, the term “partition” used in the present disclosure is used for the convenience of description and may be defined as a term “louver” or a term “viewing angle control pattern”, instead of the partition.

Each of the plurality of partitions 133 may extend between the first support member 131 and the second support member 132 in the second direction Y and may be disposed to be spaced apart from each other along the first direction X.

The plurality of partitions 133 may be disposed in an area overlapping the entire active area AA, for example, in an area overlapping both the first area A1 and the second area A2. Further, the plurality of partitions 133 may have a different height in each area. For example, a height of the plurality of partitions 133 may have a value between a first height which is the smallest height and a second height which is the largest height.

In this case, for example, a profile of light which is incident to the light controller 130, for example, an area spaced between each of the plurality of partitions 133 is narrowed in the first direction X, by the plurality of partitions 133 disposed to be spaced apart from each other. Most of the light which is restricted in the front direction, for example, in the third direction Z, may be provided to the display panel 160.

Accordingly, in the area in which the plurality of partitions 133 of the light controller 130 is disposed, for example, in the area in which the plurality of partitions 133 having a second height is disposed, light may be provided in a first range. In the area in which even though the plurality of partitions 133 is disposed, the plurality of partitions 133 which is designed to have a very small height, for example, have a first height, is disposed, the light may be provided in the second range, which is larger than the first range. Accordingly, in the case of the image which is displayed by light emitted from the first light source unit 110, in an area of the active area AA overlapping an area in which the plurality of partitions 133 of the light controller 130 is disposed, the image may be displayed at the second viewing angle. In an area overlapping an area in which the plurality of partitions 133 is designed to have a very small height, the image may be displayed at the first viewing angle. The first viewing angle may be larger than the second viewing angle. For example, the first viewing angle may be defined as a wide viewing angle and the second viewing angle may be defined as a narrow viewing angle.

Further, the light controller 130 may control the viewing angle of the image which is displayed by light emitted from the first light source unit 110 to be different in each area. For example, the light controller 130 may control a viewing angle of light which is provided from the bottom to travel in the third direction Z for each area of the active area AA. For example, the light controller 130 may control a viewing angle of the image which is displayed by light emitted from the first light source unit 110 in the second area A2 of the active area AA.

In this case, the plurality of partitions 133 having a first height, which is the smallest height, may be disposed in an area overlapping the first area A1 and the plurality of partitions 133 having a second height, which is the largest height, may be disposed in an area overlapping the second area A2. Accordingly, in the case of the image displayed by light emitted from the first light source unit 110, in the second area A2 which overlaps an area in which the plurality of partitions 133 having the second height, which is the largest height, is disposed, the viewing angle is controlled to the second viewing angle to display the image. In the first area A1 which overlaps an area in which the plurality of partitions 133 having the first height which is the smallest height is disposed, the viewing angle is not controlled and the image may be displayed at the first viewing angle.

However, this is merely illustrative, and the area in which the partition 133 is disposed is not limited thereto. For example, the plurality of partitions 133 may be disposed only in an area which overlaps the second area A2, but may not be disposed in an area which overlaps the first area A1.

The height of the plurality of partitions 133 may decrease in the direction from the second area A2 to the first area A1, for example, in a direction opposite to the first direction X. For example, the height of the plurality of partitions 133 may have the first height, which is the smallest height, in a first sub area which is the most area of the first area A1 in which the viewing angle is not substantially controlled regardless of the driving mode. The height of the plurality of partitions 133 may have the second height, which is the largest height, in the second sub area, which is the most area of the second area A2 in which the viewing angle is controlled according to the driving mode. Further, the height of the plurality of partitions 133 may be gradually decreased in a direction from the second area A2 to the first area A1 in the third sub area, which is an area between the first sub area and the second sub area and includes a boundary line between the first area A1 and the second area A2. Accordingly, the boundary visibility between the first area A1 and the second area A2 may be minimized.

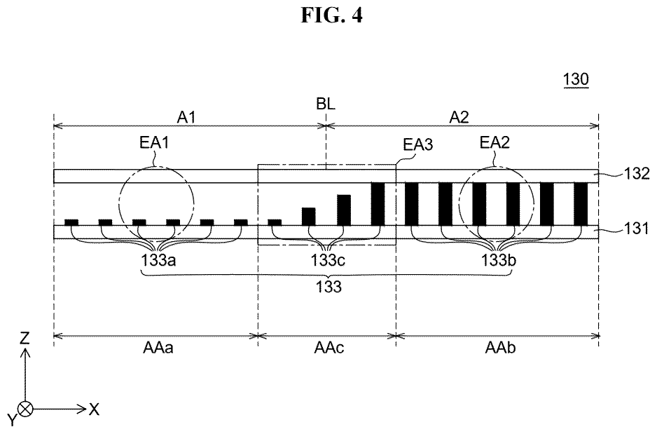

A height for each area of the plurality of partitions 133 will be described in detail below with reference to FIGS. 4 to 10.

The second light source unit 140 and the light guide plate 150 may be disposed on the light controller 130.

The second light source unit 140 may generate light and provide the generated light to the light guide plate 150. The second light source unit 140 may be disposed on a side surface of the light guide plate 150. For example, the second light source unit 140 may be an “edge-type” backlight assembly.

The second light source unit 140 may include a second circuit board 141 and a plurality of second light sources 142 disposed on the second circuit board 141.

The second circuit board 141 may include a driving circuit which drives the plurality of second light sources 142. The driving circuit of the second circuit board 141 may generate an electrical signal to drive the plurality of second light sources 142 and supply the electrical signal to the plurality of second light sources 142. However, the inventive concepts are not limited thereto, and the driving circuit may be disposed at the outside of the second circuit board 141.

The second circuit board 141 may be disposed on a side surface of the light guide plate 150. That is, the second circuit board 141 may be disposed to be parallel to the light guide plate 150. For example, the second circuit board 141 may have a shape which corresponds to one short side of the light guide plate 150 to extend along a length direction of the short side, for example, along the second direction Y. However, the inventive concepts are not limited thereto, and the second circuit board 141 may be disposed so as to correspond to one long side of the light guide plate 150.

Further, the plurality of second light sources 142 may be mounted on the second circuit board 141. For example, the plurality of second light sources 142 is disposed on the second circuit board 141 to be spaced apart from each other along the second direction Y to be mounted on a top surface which is one surface of the second circuit board 141.

Each of the plurality of second light sources 142 may be formed to emit white light, but the inventive concepts are not limited thereto, and each of the plurality of second light sources 142 may be formed to emit light with any one wavelength of red, green, and blue.

As the plurality of second light sources 142, a light emission diode (LED), a cold cathode fluorescent lamp (CCFL), or an external electrode fluorescent lamp may be used, but the inventive concepts are not limited thereto.

The light guide plate 150 may be disposed on the light controller 130 and may be disposed on a side portion of the second light source unit 140. For example, the light guide plate 150 may be disposed on the substantially same plane as the second light source unit 140.

The light guide plate 150 may be formed of a material including glass, quartz, or polymer having transparency, to efficiently guide the light. For example, the polymer may be formed of a material having a predetermined refractive index, such as acrylic resin including polymethylmethacrylate (PMMA) or polycarbonate (PC).

The light guide plate 150 guides light provided from the second light source unit 140 to allow the light to travel in a direction toward the display panel 160, for example, in the third direction Z. For example, light which is incident from the second light source unit 140, through a side surface on which the second light source unit 140 is disposed, may change the traveling direction to the third direction Z toward the display panel 160, by total reflection, while traveling in the light guide plate 150. Therefore, a uniform surface light source may be provided toward the display panel 160.

Further, the light which is provided via the optical sheet 120 and the light controller 130 from the first light source unit 110 may travel to the third direction Z which is a direction toward the display panel 160 by means of the light guide plate 150.

In the meantime, as described above, the driving mode of the display device 100 may be controlled depending on whether the second light source 142 included in the second light source unit 140 emits light.

For example, in the first mode, all the plurality of first light sources 112 of the first light source unit 110 and the plurality of second light sources 142 of the second light source unit 140 may emit light. In this case, even though in at least a partial area of the active area AA, for example, in an area overlapping the second area A2, a viewing angle of light emitted from the first light source unit 110 is controlled by the light controller 130, light emitted from the light source unit 140 travels by the light guide plate 150 in the third direction Z, which is a direction toward the display panel 160 to be provided in the entire active area AA. Therefore, the image may be displayed at the first viewing angle in the entire area of the display panel 160. Accordingly, in the first mode, the image may be displayed in a wide field-of-view mode (share mode) in the entire active area AA, for example, in both the first area A1 and the second area A2.

Further, in the second mode, the plurality of first light sources 112 of the first light source unit 110 may emit light and the plurality of second light sources 142 of the second light source unit 140 may not emit light. Therefore, an image which is displayed by the display panel 160 in the second mode may be implemented only by light provided from the first light source unit 110. In this case, in an area of the active area AA which overlaps the second area A2, the viewing angle of the light emitted from the first light source unit 110 is controlled by the light controller 130. Therefore, in the first area A1 of the display panel 160, the image may be displayed at the first viewing angle and in the second area A2 of the display panel 160, the image may be displayed at the second viewing angle. Accordingly, in the second mode, the image may be displayed in the wide field-of-view mode (share mode) in the first area A1 of the active area AA and the image may be displayed in the narrow field-of-view mode (private mode) in the second area A2 of the active area AA.

As described above, the display device 100 according to embodiments of the invention controls whether the second light source unit 140 disposed on the top, among the plurality of light source units disposed below the display panel 160, that is, the first light source unit 110 and the second light source unit 140 emits light. By doing this, the display device may control the display panel 160 in the first mode or the second mode.

Hereinafter, the light controller 130 of the display device 100 according to embodiments of the invention will be described in more detail with reference to FIGS. 4 to 10.

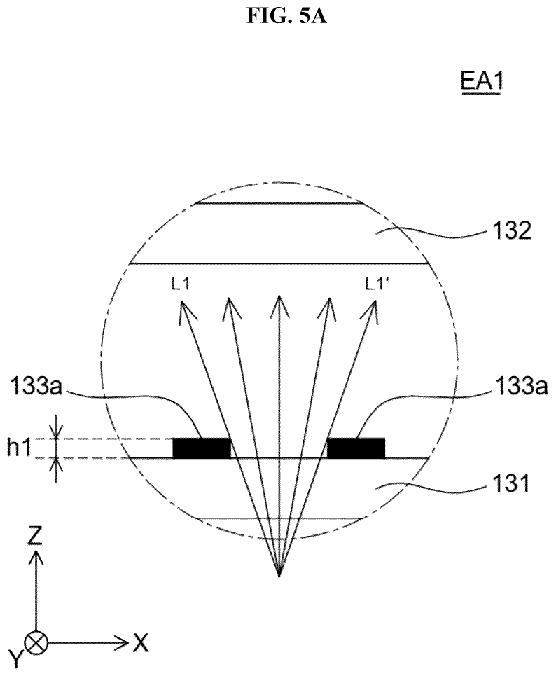

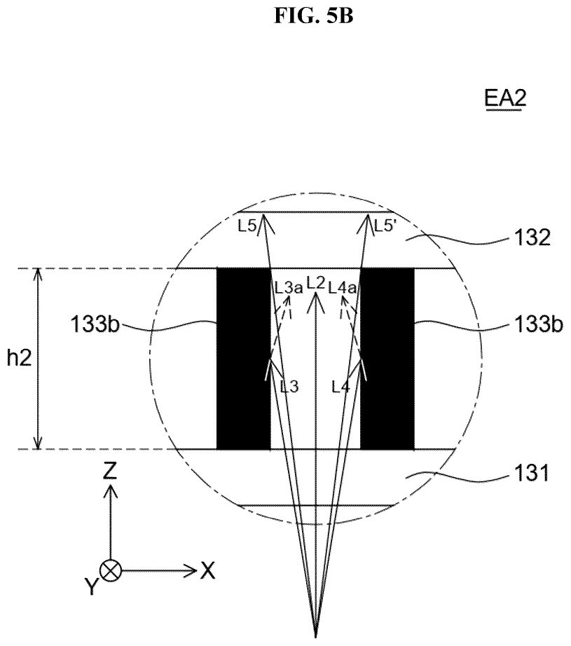

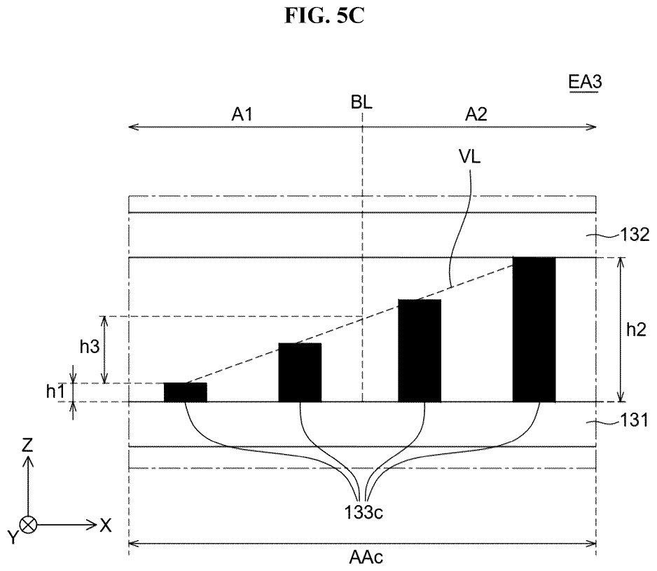

FIG. 4 is a side view schematically illustrating an example of a light controller included in a display device of FIG. 2. FIG. 5A is an enlarged view illustrating an example of a part EA1 of FIG. 4. FIG. 5B is an enlarged view illustrating an example of a part EA2 of FIG. 4. FIG. 5C is an enlarged view illustrating an example of a part EA3 of FIG. 4.

The light controller 130 illustrated in FIG. 4 represents an example of the light controller 130 included in the display device 100 which has been described with reference to FIG. 2.

Referring to FIGS. 2 and 4, the light controller 130 includes a first support member 131, a second support member 132 opposing the first support member 131, and a plurality of partitions 133 disposed between the first support member 131 and the second support member 132. By doing this, the light controller may control a viewing angle or an emission angle of light which travels toward the third direction Z, which is perpendicular to the active area AA, according to the first direction X.

The first support member 131 and the second support member 132 may be disposed to be spaced apart from each other with the partition 133 therebetween. The first support member 131 is disposed below the plurality of partitions 133 to support the plurality of partitions 133 and the second support member 132 is disposed above the plurality of partitions 133 to support the plurality of partitions 133. However, the inventive concepts are not limited thereto and bottom surfaces of the plurality of partitions 133 may be in contact with the first support member 131 and top surfaces of the plurality of partitions 133 may be spaced apart from the second support member 132.

The first support member 131 and the second support member 132 include transparent material to allow light to pass therethrough. For example, each of the first support member 131 and the second support member 132 may include a plastic member. For example, each of the first support member 131 and the second support member 132 may include polycarbonate. However, the material of each of the first support member 131 and the second support member 132 is not limited thereto. According to this embodiment, each of the first support member 131 and the second support member 132 may include polymer, such as polystyrene, polyvinyl alcohol, polymethyl methacrylate, polyethersulfone, polyacrylate, polyetherimide, polyethylene naphthalate, polyethylene terephthalate, polyphenylene sulfide, polyarylate, or polyimide.

The plurality of partitions 133 may be disposed between the first support member 131 and the second support member 132. Each of the plurality of partitions 133 may be coupled to the first support member 131 and the second support member 132 by means of a transparent adhesive, but the inventive concepts are not limited thereto.

Each of the plurality of partitions 133 extends along the second direction Y and may be spaced apart from each other along the first direction X. Accordingly, a space may be formed between the plurality of partitions 133. Such a space may be filled with air or a transparent insulating material, but the inventive concepts are not limited thereto.

In the meantime, an interval along the first direction X, between two adjacent partitions 133, among the plurality of partitions 133, may be determined by comprehensively considering a thickness of the light controller 130, an emission angle of light emitted from the light controller 130, and a distance between the light controller 130 and the display panel 160. By doing this, the image displayed by the light provided from the first light source unit 110 is displayed on the second area A2 at the second viewing angle.

Each of the plurality of partitions 133 may include a light absorption material or may be coated with a light absorbing agent to absorb light entering from the outside. For example, each of the plurality of partitions 133 may include a carbon-based black pigment. However, a material of the plurality of partitions is not limited thereto. Each of the plurality of partitions 133 may include at least any one of titanium (Ti), tungsten (W), chromium (Cr), molybdenum (Mo), an alloy of molybdenum (Mo) and titanium (Ti) (MoTi), vanadium (V), niobium (Nb), silicon nitride (SiN), titanium nitride (TiN), silicon carbide (SiC), tantalum (Ta), manganese (Mn), cobalt (Co), nickel (Ni), copper oxide (CuO), aluminum oxide (Al₂O₃), iron oxide (Fe₃O₄), and tantalum oxide (Ta₂O₅) having a high light absorptance or include an organic material having a high light absorptance.

Further, each of the plurality of partitions 133 may have a quadrangular columnar shape. For example, each of the plurality of partitions 133 may have a quadrangular columnar shape in which both side surfaces opposing along the second direction Y have a rectangular shape. Therefore, each of the plurality of partitions 133 may have a rectangular shape as seen from a plane defined by the first direction X and the third direction Z. Therefore, a top surface and a bottom surface of each of the plurality of partitions 133 may be parallel to the first support member 131 and the second support member 132. Both side surfaces of the plurality of partitions 133 which are opposite to each other along the first direction X may be perpendicular to the first support member 131 and the second support member 132. For example, both side surfaces of the plurality of partitions 133 which are opposite to each other along the first direction X may be parallel to the third direction Z which is perpendicular to each of the first support member 131 and the second support member 132.

In the meantime, referring to FIG. 4, the active area AA may be divided into a plurality of sub areas AAa, AAb, and AAc. For example, the active area AA may be divided into a first sub area AAa, a second sub area AAb, and a third sub area AAc. Here, the first sub area AAa corresponds to a partial area of the first area A1, the second sub area AAb corresponds to a partial area of the second area A2, and the third sub area AAc is an area which is disposed between the first sub area AAa and the second sub area AAb and includes a boundary line BL between the first area A1 and the second area A2. The third sub area may be defined as an area including an area excluding the first sub area AAa from the first area A1 and an area excluding the second sub area AAb from the second area A2.

The plurality of partitions 133 may be disposed on the entire active area AA. For example, the plurality of partitions 133 may include a plurality of first partitions 133a disposed on the first sub area AAa, a plurality of second partitions 133b disposed on the second sub area AAb, and a plurality of third partitions 133c disposed on the third sub area AAc.

The plurality of first partitions 133a may be disposed between the first support member 131 and the second support member 132 on the first sub area AAa. For example, each of the plurality of first partitions 133a extends along the second direction Y and may be disposed to be spaced apart from each other along the first direction X. Accordingly, a space may be formed between the plurality of first partitions 133a.

The plurality of second partitions 133b may be disposed between the first support member 131 and the second support member 132 on the second sub area AAb. For example, each of the plurality of second partitions 133b extends along the second direction Y and may be disposed to be spaced apart from each other along the first direction X. Accordingly, a space may be formed between the plurality of second partitions 133b.

The plurality of third partitions 133c may be disposed between the first support member 131 and the second support member 132 on the third sub area AAc. For example, each of the plurality of third partitions 133c extends along the second direction Y and may be disposed to be spaced apart from each other along the first direction X. Accordingly, a space may be formed between the plurality of third partitions 133c.

The plurality of partitions 133 may have a different height in each area. As described above, an emission angle of light emitted from the light controller 130 in the first direction X may be restricted for each area by the plurality of partitions 133 having different heights in each area.

According to an embodiment, an emission angle may refer to an angle formed by a traveling direction of light emitted from the light controller 130 and the third direction Z on the plane defined by the first direction X and the third direction Z.

Further, in the present embodiment, the height may refer to a length or a distance along the third direction Z.

To be more specific, a height of the first partition 133a may be different from a height of the second partition 133b. For example, the height of the first partition 133a may be less than the height of the second partition 133b. For example, the first partition 133a disposed on the first sub area AAa may have a first height and the second partition 133b disposed on the second sub area AAb may have a second height different from the first height.

For example, further referring to FIG. 5A, the first partition 133a may have a first height h1. Here, the first height h1 may correspond to a minimum height which is possible in the process.

As described above, each of the plurality of first partitions 133a has a very small height so that an emission angle of light which is incident to most of the first area A1, for example, the first sub area AAa, may not be substantially restricted. For example, as illustrated in FIG. 5A, the first height h1 of the plurality of first partitions 133a has a very small value so that upper ends of two first partitions 133a, which are spaced apart from each other, may be located to be adjacent to a top surface of the first support member 131. In this case, a traveling path of most of light provided from the bottom of the light controller 130 is formed between light which passes through upper end insides of two separated first partitions 133a, for example, formed between first light L1 and first ‘light L1’. Therefore, most of light provided from the bottom of the light controller 130 may be emitted upwardly from the light controller 130.

Accordingly, in the first sub area AAa in which the plurality of first partitions 133a are disposed, an emission angle of light provided from the bottom of the light controller 130, for example, light provided from the first light source unit 110, is not substantially restricted. Therefore, the light may be provided in a second range which is larger than a first range.

Further, further referring to FIG. 5B, the second partition 133b may have a second height h2 which is greater than the first height h1. Here, the second height h2 may be substantially the same as a length of a space between the first support member 131 and the second support member 132 along the third direction Z. However, the second height h2 is not limited thereto and the second height h2 of each of the plurality of second partitions 133b may be less than a length of the space between the first support member 131 and the second support member 132 along the third direction Z.

As described above, an emission angle of light emitted from the light controller 130 in the first direction X may be restricted by the plurality of second partitions 133b having a second height h2, in the second sub area AAb. For example, light provided from the bottom of the light controller 130, for example, light provided from the first light source unit 110 has a light profile which is reduced or narrowed by the plurality of second partitions 133b along the first direction X. Accordingly, in the second sub area AAb, in which the second partition 133b is disposed, the emission angle of light in the first direction X may be restricted.

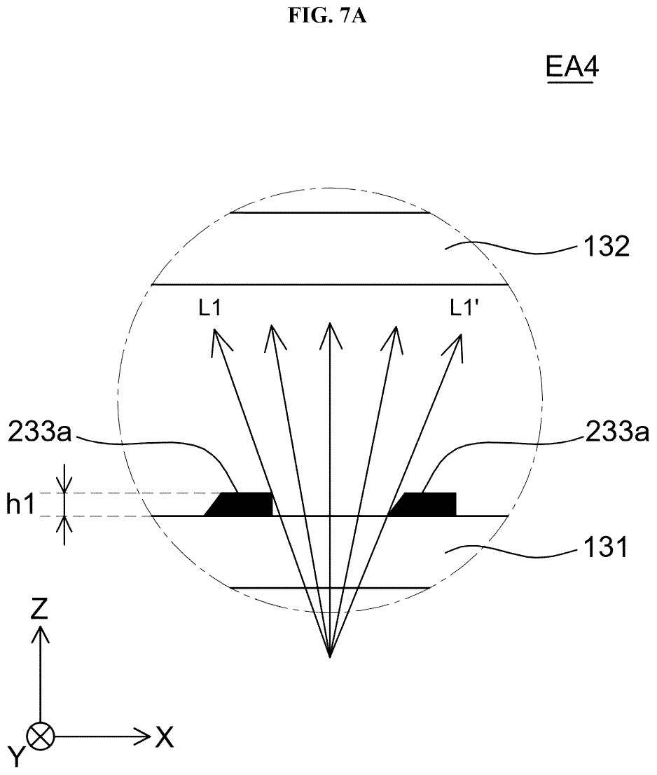

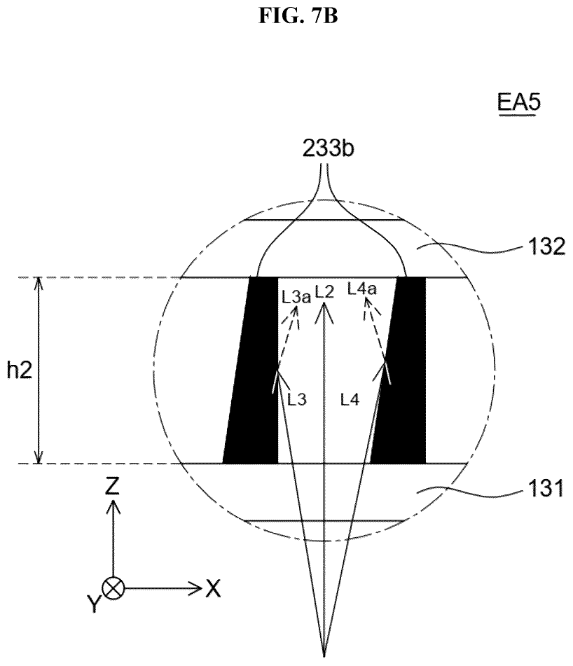

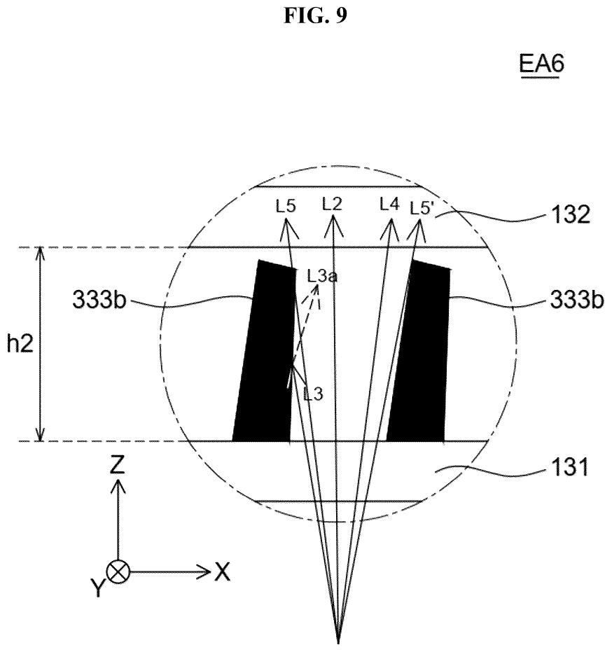

For example, referring to FIG. 5B, and similarly shown in FIGS. 7B and 9, among light provided from the bottom of the light controller 130, second light L2 having a light path formed in the third direction Z, which is a vertical direction, between two separated partitions 133, is not blocked by the second partition 133b, but may be emitted to the outside, that is, the upward direction of the light controller 130.

Further, among light provided from the bottom of the light controller 130, light which passes through the upper end inside of two separated second partitions 133b, that is, light between fifth light L5 and fifth ‘light L5’, may be emitted to an upward direction of the light controller 130.

However, when a light path is formed in a direction having a predetermined angle along the first direction X in the third direction Z between two separated second partitions 133b and the second partition 133b is located on the light path, among light provided from the bottom of the light controller 130, at least some of light may be blocked by the second partition 133b. That is, light provided from the bottom of the light controller 130 at an angle greater than an incident angle of the fifth light L5 and the fifth ‘light L5’ is blocked by the plurality of second partitions 133b so as not to be emitted to an upward direction of the light controller 130. For example, at least some of each of third light L3 and fourth light L4 provided from the bottom of the light controller 130 is absorbed by the second partition 133b and is not emitted to the outside.

In the case of light with a light path on which the second partition 133b is located, each of the plurality of second partitions 133b includes a light absorption material or is coated with the light absorption agent so that most light is absorbed by the second partition 133b. However, the remaining light which is not absorbed by the second partition 133b is totally reflected from the second partition 133b to be emitted to the outside. For example, the third light portion L3a of third light L3, which is not absorbed by the second partition 133b, and fourth light portion L4a of fourth light L4, which is not absorbed by the second partition 133b, among fourth light L4, are totally reflected from the second partition 133b to be emitted to the outside.

Accordingly, in the second sub area AAb in which the plurality of second partitions 133b are disposed, an emission angle of light provided from the bottom of the light controller 130, for example, light provided from the first light source unit 110 is restricted. Therefore, the light may be provided in the first range which is smaller than the second range.

As described above, in the second area A2 in which the plurality of second partitions 133b having a second height h2 in the most area, for example, in the second sub area AAb is disposed, an emission angle of light in the first direction X is restricted to provide light in the first range. In the first area A1 in which the plurality of first partitions 133a having a first height h1 in the most area, for example, in the first sub area AAa is disposed, an emission angle of light is not restricted to provide light in the second range which is larger than first range. Accordingly, in the case of an image which is displayed by light emitted from the first light source unit 110 disposed below the light controller 130, in the second area A2 of the active area AA, the image may be entirely displayed at the second viewing angle, for example, at a narrow viewing angle and in the first area A1, the image may be entirely displayed at the first viewing angle, for example, at a wide viewing angle.

Further, referring to FIG. 4, the plurality of third partitions 133c may have a value between the first height h1 and the second height h2. For example, the heights of the plurality of third partitions 133c may be gradually increased toward the first direction X. For example, the heights of the plurality of third partitions 133c may be gradually increased from the first area A1 or the first sub area AAa to the second area A2 or the second sub area AAb. For example, a third partition 133c, among the plurality of third partitions 133c, which is the most adjacent to the first sub area AAa, has the same height as the first partition133a. A third partition 133c, among the plurality of third partitions 133c, which is the most adjacent to the second sub area AAb, has the same height as the second partition 133b. The remaining third partition 133c, among the plurality of third partitions 133c, has a height between the first height h1 and the second height h2, and may be increased toward the first direction X.

In other words, from the vicinity of the boundary line BL between the first area A1 and the second area A2, the height of the plurality of third partitions 133c may be gradually increased toward the first direction X, that is, a direction directed to the second sub area AAb or the second area A2. Accordingly, in the case of the image which is displayed by light which is incident to the light controller 130, a boundary visibility according to a viewing angle difference of the first area A1 and the second area A2 may be minimized in the boundary between the second area A2 and the first area A1. In the second area A2, a viewing angle is entirely restricted to display an image at a second viewing angle, for example, a narrow viewing angle and in the first area A1, the viewing angle is not substantially restricted to display an image at a first viewing angle, for example, a wide viewing angle.

The boundary between the first area A1 and the second area A2 of the active area AA may be defined in the third sub area AAc. In order to describe this in more detail, further referring to FIG. 5C, on a virtual line VL connecting center points of top surfaces of the plurality of third partitions 133c, a straight line parallel to the third direction Z, with respect to a point where a height from the first support member 131 is a third height h3, which is half the second height h2, which is the height of the second partition 133b disposed on the second area A2, may be defined as the boundary line BL between the first area A1 and the second area A2. However, it is merely illustrative to divide the first area A1 and the second area A2 in the active area AA along the boundary line BL and the first area A1 and the second area A2 in the active area AA may be defined in various ways depending on the design. For example, depending on the design, on the virtual line VL connecting center points of top surfaces of the plurality of third partitions 133c, a straight line parallel to the third direction Z based on a point having a height equal to ⅔ of the second height h2 may be defined as the boundary line BL between the first area A1 and the second area A2.

Accordingly, in the case of an image displayed by light provided from the bottom of the light controller 130, for example, the first light source unit 110, a plurality of second partitions 133b having a second height h2 is disposed on the most area of the second area A2, for example, on the second sub area AAb, so that in the second area A2, the viewing angle is controlled to the second viewing angle to display the image. Further, for example, a plurality of first partitions 133a having a first height h1, which is less than the second height h2, is disposed on the most area of the first area A1, for example, on the first sub area AAa, so that in the first area A1, the viewing angle is not substantially controlled to display the image at the first viewing angle.

Further, a height of the plurality of third partitions 133c disposed in an area in the vicinity of the boundary line BL between the first area A1 and the second area A2 in which the viewing angle is controlled to be different according to the driving mode, for example, in the third sub area AAc is designed to have a value between the first height h1 and the second height h2 and to be gradually changed toward one direction. Therefore, the boundary visibility between the first area A1 and the second area A2 may be minimized.

Further, during the manufacturing process of the light controller 130, the plurality of partitions 133 are not only formed in the second area A2 for controlling the viewing angle, but also formed in the entire active area AA so that the manufacturing process of the light controller 130 may be more simplified.

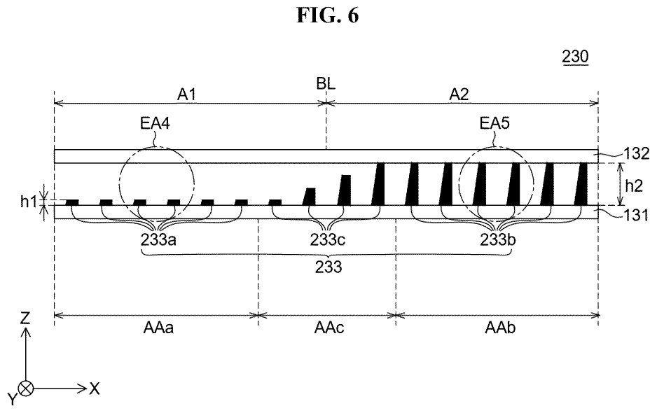

FIG. 6 is a side view schematically illustrating another example of a light controller included in a display device of FIG. 2. FIG. 7A is an enlarged view illustrating an example of a part EA4 of FIG. 6. FIG. 7B is an enlarged view illustrating an example of a part EA5 of FIG. 6.

In the meantime, a light controller 230 illustrated in FIG. 6 represents another embodiment of the light controller 130 included in the display device 100 which has been described with reference to FIG. 2.

Further, FIGS. 6 to 7B illustrate a modified version of the embodiment of FIGS. 4 to 5C with regard to the shape of a plurality of partitions 233 included in a light controller 230. Accordingly, in FIGS. 6 to 7B, in order to avoid a redundant description, differences from the above-described exemplary embodiments will be mainly described.

Referring to FIGS. 2 and 6, the light controller 230 includes a first support member 131, a second support member 132 which is opposite to the first support member 131, and a plurality of partitions 233 disposed between the first support member 131 and the second support member 132. By doing this, the light controller may control a viewing angle or an emission angle of light which travels toward the third direction Z, which is perpendicular to the active area AA, according to the first direction X.

The plurality of partitions 233 may be disposed between the first support member 131 and the second support member 132. For example, each of the plurality of partitions 233 extends along the second direction Y and may be disposed to be spaced apart from each other along the first direction X. Accordingly, a space may be formed between the plurality of partitions 233.

The plurality of partitions 233 may be disposed on the entire active area AA. For example, the plurality of partitions 233 may include a plurality of first partitions 233a disposed on the first sub area AAa, a plurality of second partitions 233b disposed on the second sub area AAb, and a plurality of third partitions 233c disposed on the third sub area AAc.

Each of the plurality of partitions 233 may have a different height in each area. For example, the plurality of first partitions 233a may have a first height h1, which is the smallest height, and the plurality of second partitions 233b may have a second height h2, which is the largest height. As described above, an emission angle of light emitted from the light controller 230 in the first direction X may be restricted for each area by the plurality of partitions 233 having different heights in each area.

Further, the plurality of third partitions 233c may have a height between the first height h1 and the second height h2. For example, the height of the plurality of third partitions 233c may be increased toward the first direction X, for example, from the first area A1 to the second area A2. Accordingly, the boundary visibility between the first area A1 and the second area A2 according to the difference in the viewing angle may be minimized.

Further, each of the plurality of partitions 233 may have the quadrangular columnar shape. For example, each of the plurality of partitions 233 may have a quadrangular columnar shape in which both side surfaces opposing along the second direction Y have a trapezoidal shape. Therefore, each of the plurality of partitions 233 may have a trapezoidal shape as seen from a plane defined by the first direction X and the third direction Z. Accordingly, a top surface and a bottom surface of each of the plurality of partitions 233 may be parallel to the first support member 131 and the second support member 132. One side surface between both side surfaces of the plurality of partitions 233, which are opposite to each other along the first direction X, may be perpendicular to the first support member 131 and the second support member 132. The other side surface between both side surfaces of each of the plurality of partitions 233, which are opposite to each other along the first direction X, may have an inclined plane at a predetermined angle with respect to the first support member 131 and the second support member 132. For example, one side surface located closer to the first direction X, between both side surfaces of each of the plurality of partitions 133, which are opposite to each other along the first direction X, may be parallel to the third direction Z which is perpendicular to the first support member 131 and the second support member 132. The other side surface located in the opposite direction to the first direction X, between both side surfaces of each of the plurality of partitions 133, which are opposite to each other along the first direction X, may have an inclined plane at a predetermined angle with respect to the third direction Z.

As described above, an emission angle of light emitted from the light controller 230 in the first area A1 in which the viewing angle is not substantially restricted may be further increased and an emission angle of light emitted from the light controller 230 in the second area A2 in which the viewing angle is controlled according to the driving mode may be more effectively restricted, by the plurality of partitions 233 having a trapezoidal shape on a side surface.

To be more specific, further referring to FIG. 7A, the first partition 233a may have a first height h1. Here, substantially the same as or similar to what has been described with reference to FIG. 5A, the height h1 may correspond to a minimum height which is possible in the process. As described above, the plurality of first partitions 233a have a very small height so that an emission angle of light which is incident to a most area of the first area A1, for example, the first sub area AAa, may not be substantially restricted.

Here, the plurality of first partitions 233a which are disposed on the first sub area, AAa has a quadrangular columnar shape in which both side surfaces opposing along the second direction Y are trapezoid so that a range of an emission angle at which light provided from the bottom of the light controller 230 is emitted upwardly from the light controller 230 may be increased.

For example, as illustrated in FIG. 7A, first ‘light L1’, among light which is provided from the bottom of the light controller 230 to be emitted upwardly through a space between two separated first partitions 233a passes through an inside of an end of a side surface inclined along the first direction X, between both side surfaces which are opposite to each other along the first direction X of the first partition 233a. Accordingly, an emission angle according to the first ‘light L1’ may be further increased.

Therefore, an emission angle of light which is emitted from the light controller 230 in the first area A1 in which the viewing angle is not substantially restricted may be further increased regardless of the driving mode.

Next, further referring to FIG. 7B, a profile of light provided from the bottom of the first light controller 230, for example, light provided from the first light source unit 110 is reduced or narrowed along the first direction X by the plurality of second partitions 233b disposed in the second area A2, for example, in the second sub area AAb, so that the emission angle of the corresponding light in the first direction X may be restricted.

Specifically, among light provided from the bottom of the light controller 230, when a light path is formed in a direction having a predetermined angle along the first direction X with respect to the third direction Z, between two separated second partitions 233b, and the inclined side surface of the second partition 233b is located on the light path, if the remaining light of light, which is not absorbed by the second partition 233b is totally reflected, the light may be guided more toward the third direction Z, which is a vertical direction, as compared with the case when the light is totally reflected by a vertical side surface of the second partition 233b. For example, at least a part of third light L3, which is provided from the bottom of the light controller 230 to travel to a vertical side surface of the second partition 233b is absorbed by the second partition 233b, and third light portion L3a, which is not absorbed by the second partition 233b, is totally reflected from the vertical side surface of the second partition 233b. At least a part of fourth light L4, which is provided from the bottom of the light controller 230 to travel to the inclined side surface of the second partition 233b, is absorbed by the second partition 233b, and fourth light portion LAa, which is not absorbed by the second partition 233b is totally reflected from the inclined side surface of the second partition 233b. Here, depending on an incident angle difference on the vertical side surface and the inclined side surface of the second partition 233b, fourth light portion L4a, which is totally reflected by the inclined side surface of the second partition 233b, may be guided to the third direction Z, which is a vertical direction, more than the third light portion L3a, which is totally reflected by the vertical side surface of the second partition 233b. Accordingly, more light which is directed to the display panel 160 in the second area A2 may be condensed.

Further, the fourth light portion L4a, which is totally reflected by the inclined side surface of the second partition 233b, travels toward the opposite direction to the first direction X in which the first area A1 is located. When the fourth light is totally reflected, the fourth light is guided more to the third direction Z, which is a vertical direction by the incident angle along the inclined side surface. Accordingly, as compared with the fourth light portion L4a of the embodiment of FIG. 5B, which is totally reflected by the vertical side surface of the second partition 133b, the fourth light portion LAa of the embodiment of FIG. 7B, which is totally reflected by the inclined side surface of the second partition 233b, may be more shifted to the first direction X. Accordingly, in the case of the image which is displayed on the second area A2 by the light provided from the first light source unit 110, a viewing angle to the first area A1 may be more effectively restricted.

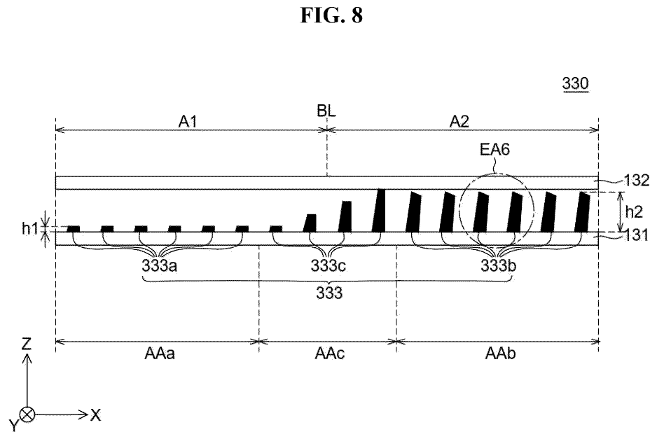

FIG. 8 is a side view schematically illustrating still another example of a light controller included in a display device of FIG. 2. FIG. 9 is an enlarged view illustrating an example of a part EA6 of FIG. 8.

A light controller 330 illustrated in FIG. 8 represents still another embodiment of the light controller 130 included in the display device 100, which has been described with reference to FIG. 2.

Further, FIGS. 8 and 9 illustrate a modified version of the embodiment of FIGS. 6 to 7B with regard to a shape of a plurality of partitions 333 included in a light controller 330. Accordingly, in FIGS. 8 and 9, in order to avoid a redundant description, differences from the above-described embodiments will be mainly described.

Referring to FIGS. 2 and 8, the light controller 330 includes a first support member 131, a second support member 132 opposing the first support member 131, and a plurality of partitions 333 disposed between the first support member 131 and the second support member 132. By doing this, the light controller may control a viewing angle or an emission angle of light which travels toward the third direction Z, which is perpendicular to the active area AA, according to the first direction X.

The plurality of partitions 333 may be disposed between the first support member 131 and the second support member 132. For example, each of the plurality of partitions 333 extends along the second direction Y and may be disposed to be spaced apart from each other along the first direction X. Accordingly, a space may be formed between the plurality of partitions 333.

The plurality of partitions 333 may be disposed on the entire active area AA. For example, the plurality of partitions 333 may include a plurality of first partitions 333a, which are disposed on the first sub area AAa and have a first height h1, a plurality of second partitions 333b, which are disposed on the second sub area AAb and have a second height h2, and a plurality of third partitions 333c, which are disposed on the third sub area AAc and have a height between the first height h1 and the second height h2.

Further, each of the plurality of partitions 333 may have a quadrangular columnar shape.

For example, each of the plurality of first partitions 333a disposed in the first sub area AAa and each of the plurality of third partitions 333c disposed in the third sub area AAc may have a quadrangular columnar shape, in which both side surfaces opposing along the second direction Y have a trapezoidal shape.

Even though in FIG. 8, it has described that the first partitions 333a and the third partitions 333c have side surfaces opposing along the second direction Y which are trapezoidal, this is merely illustrative and the inventive concepts are not limited thereto. For example, as described with reference to FIGS. 4 to 5C, the first partitions 333a and the third partitions 333c may have a quadrangular columnar shape in which both side surfaces opposing along the second direction Y have a rectangular shape.

Further, the plurality of second partitions 333b disposed in the second sub area AAb may have a quadrangular columnar shape in which both side surfaces opposing along the second direction Y have an inclined shape.

To be more specific, further referring to FIG. 9, the plurality of second partitions 333b may have a quadrangular shape which is inclined at a predetermined angle with respect to a direction perpendicular to the active area AA, that is, the third direction Z, as seen from a plane defined by the first direction X and the third direction Z. For example, each of the plurality of second partitions 333b may have a quadrangular shape, which is rotated by a predetermined angle in a clockwise direction, on the plane defined along the first direction X and the third direction Z with respect to the third direction Z. Accordingly, both side surfaces of each of the plurality of second partitions 333b, which oppose each other along the first direction X, may lie along a plane inclined to the first direction X by a predetermined angle, with respect to the third direction Z.

Accordingly, a traveling path of each of fifth light L5 and fifth ‘light L5’, which pass through an inside of an upper end of two separated second partitions 333b, among light provided from the bottom of the light controller 330, may be formed by being shifted more to the first direction X by the second partition 333b, which is inclined at a predetermined angle with respect to the third direction Z.

Further, in the case of third light L3, among light with a light path on which the second partition 333b is located, according to the incident angle, light portion L3a of the third light L3, which is not absorbed by the second partition 333b, is totally reflected by the second partition 333b to be emitted to the outside. In this case, the second partition 333b lies along a plane which is inclined to the first direction X by a predetermined angle, with respect to the third direction Z, so that the path of the third light portion L3a, which is totally reflected by the second partition 333b, may be shifted more to the first direction X by the inclination of the plane onto which the third light L3 is incident.

As described above, the plurality of second partitions 333b disposed on the second area A2, for example, on the second sub area AAb, has a quadrangular columnar shape in which both side surfaces opposing along the second direction Y have an inclined quadrangular shape. Accordingly, light emitted from the light controller 330 in the second area A2 may be totally shifted to the first direction X. Accordingly, in the case of the image which is displayed on the second area A2 by the light provided from the first light source unit 110, a viewing angle to the first area A1 may be more effectively restricted.

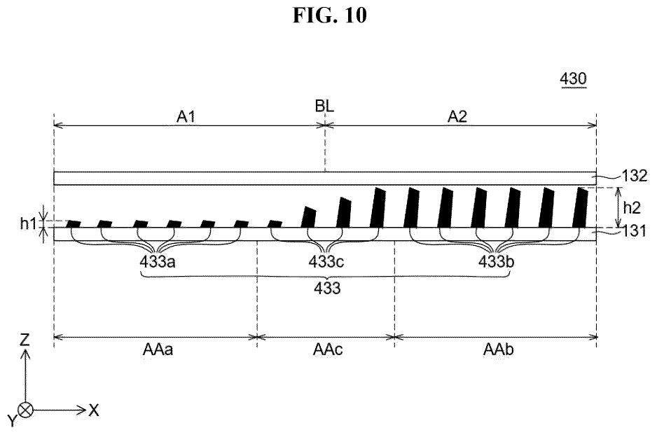

FIG. 10 is a side view schematically illustrating still another example of a light controller included in a display device of FIG. 2.

In the meantime, a light controller 430 illustrated in FIG. 10 represents still another embodiment of the light controller 130 included in the display device 100 which has been described with reference to FIG. 2.

Further, FIG. 10 illustrates a modified version of the embodiment of FIGS. 8 and 9 with regard to a shape of a plurality of partitions 433 included in a light controller 430. Accordingly, in FIG. 10, in order to avoid a redundant description, differences from the above-described embodiments will be mainly described.

Referring to FIGS. 2 and 10, the light controller 430 includes a first support member 131, a second support member 132 which is opposite to the first support member 131, and a plurality of partitions 433 disposed between the first support member 131 and the second support member 132. By doing this, the light controller may control a viewing angle or an emission angle of light which travels toward the third direction Z which is perpendicular to the active area AA, according to the first direction X.

The plurality of partitions 433 may be disposed between the first support member 131 and the second support member 132. For example, each of the plurality of partitions 433 extends along the second direction Y and may be disposed to be spaced apart from each other along the first direction X. Accordingly, a space may be formed between each of the plurality of partitions 433.

The plurality of partitions 433 may be disposed on the entire active area AA. For example, the plurality of partitions 433 may include a plurality of first partitions 433a, which are disposed on the first sub area AAa and have a first height h1, a plurality of second partitions 433b, which are disposed on the second sub area AAb and have a second height h2, and a plurality of third partitions 433c, which are disposed on the third sub area AAc and have a height between the first height h1 and the second height h2.

Further, each of the plurality of partitions 433 may have a quadrangular columnar shape.

For example, each of the plurality of first partitions 433a disposed on the first sub area AAa, the plurality of second partitions 433b disposed on the second sub area AAb, and the plurality of third partitions 433c disposed in the third sub area AAc may have a quadrangular columnar shape in which both side surfaces opposing along the second direction Y have an inclined quadrangular shape. Accordingly, since light emitted from the light controller 430 is totally shifted in the first direction X, in the case of the image which is displayed by the light provided from the first light source unit 110 on the second area A2, a viewing angle to the first area A1 may be more effectively restricted.

Further, during the manufacturing process of the light controller 430, the plurality of partitions 433 having the same shape on the entire area of the light controller 430, for example, on the first sub area AAa, the second sub area AAb, and the third sub area AAc is formed so that the manufacturing process of the light controller 430 may be more simplified.

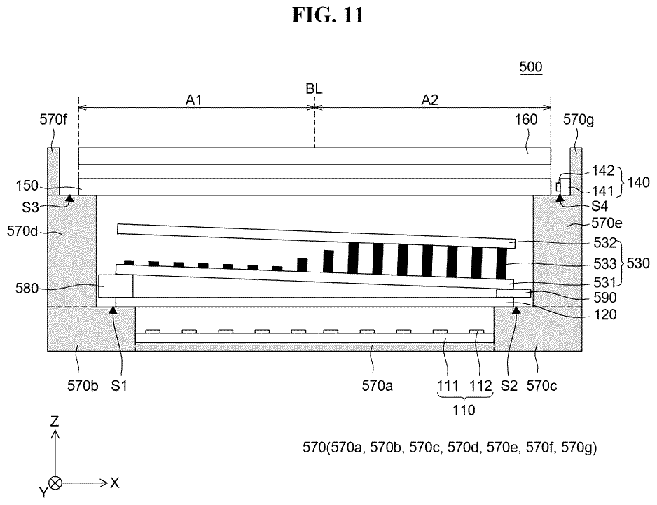

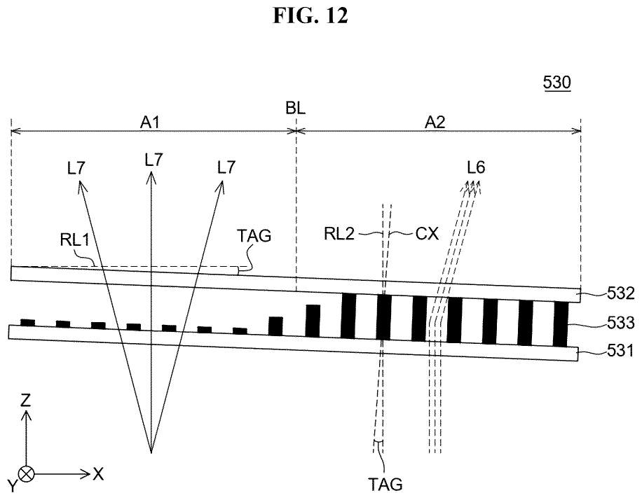

FIG. 11 is a side view of a display device according to another embodiment of the invention. FIG. 12 is a side view illustrating an example of a light controller included in a display device of FIG. 11.

A display device 500 of FIG. 11 further includes a cover 570, a first fixing member 580, and a second fixing member 590, and a light controller 530 is formed to be inclined so that the display device 500 is a modified version of the embodiment of the display device 100 which has been described with reference to FIG. 2. Accordingly, in FIGS. 11 and 12, in order to avoid a redundant description, differences from the above-described embodiments will be mainly described.

FIGS. 11 and 12 illustrate that a shape of a plurality of partitions 533 included in the light controller 530 is substantially the same as or similar to the shape of the partition 133, which has been described with reference to FIGS. 4 to 5C, but this is merely illustrative and the inventive concepts are not limited thereto. For example, the plurality of partitions 533 included in the light controller 530 may have a shape of the partitions 233, 333, and 433 according to any one embodiment, among a shape of the partition 233 which has been described with reference to FIGS. 6 to 7B, a shape of the partition 333 which has been described with reference to FIGS. 8 and 9, or a shape of the partition 433 which has been described with reference to FIG. 10.

Referring to FIG. 11, the display device 500 according to another embodiment of the invention may include a first light source unit 110, at least one optical sheet 120, a light controller 530, a second light source unit 140, a light guide plate 150, a display panel 160, and a cover 570. Further, the display device 500 may further include a first fixing member 580 and a second fixing member 590. In the meantime, the term “fixing member” used in the present embodiment is used for the convenience of description and may also be defined by a term “support plate”, instead of the fixing member.

The cover 570 is an external cover of the display device 500 and may support or accommodate various configurations of the display device 500, for example, the first light source unit 110, at least one optical sheet 120, the light controller 530, the second light source unit 140, the light guide plate 150, and the display panel 160. For example, the cover 570 may be a housing.

To this end, the cover 570 has a top-open shape and may include a bottom portion 570a, a first side portion 570b, a second side portion 570c, a third side portion 570d, a fourth side portion 570e, a fifth side portion 570f, and a sixth side portion 570g. The bottom portion 570a, the first side portion 570b, the second side portion 570c, the third side portion 570d, the fourth side portion 570e, the fifth side portion 570f, and the sixth side portion 570g are integrally formed to configure the cover 570. Therefore, in this way, the cover 570 is divided into regions based on a plane, for example, a plane defined by the first direction X and the third direction Z and this is merely illustrative for the convenience of explanation, and the cover 570 may be divided in various ways.

The bottom portion 570a of the cover 570 may be disposed on the lowermost portion. For example, the bottom portion 570a of the cover 570 is disposed on the lowermost portion of the display device 500 to support the first light source unit 110.

The first side portion 570b and the second side portion 570c of the cover 570 may be disposed on both sides of the bottom portion 570a. For example, the first side portion 570b and the second side portion 570c of the cover 570 may be in contact with both ends of the bottom portion 570a. As described above, the first side portion 570b and the second side portion 570c may be integrally formed with the bottom portion 570a.

The first side portion 570b and the second side portion 570c of the cover 570 may have the same width. For example, a width of the first side portion 570b in the first direction X and a width of the second side portion 570c in the first direction X may be equal.

Further, the first side portion 570b and the second side portion 570c of the cover 570 may have the same height. For example, a height of the first side portion 570b in the third direction Z and a height of the second side portion 570c in the third direction Z may be equal.

A space between the first side portion 570b and the second side portion 570c may be formed above the bottom portion 570a, by the shape of the bottom portion 570a, the first side portion 570b, and the second side portion 570c of the cover 570. Therefore, the first light source unit 110 may be disposed in the space between the first side portion 570b and the second side portion 570c above the bottom portion 570a.

Further, the third side portion 570d of the cover 570 may be disposed above the first side portion 570b and the fourth side portion 570e of the cover 570 may be disposed above the second side portion 570c. For example, the third side portion 570d of the cover 570 may be in contact with an upper surface of the first side portion 570b and the fourth side portion 570e of the cover 570 may be in contact with an upper surface of the second side portion 570c. As described above, the third side portion 570d and the fourth side portion 570e may be integrally formed with the first side portion 570b and the second side portion 570c.

The third side portion 570d and the fourth side portion 570e of the cover 570 may have the same width. For example, a width of the third side portion 570d in the first direction X and a width of the fourth side portion 570e in the first direction X may be equal.

Widths of the third side portion 570d and the fourth side portion 570e of the cover 570 in the first direction X may be less than the widths of the first side portion 570b and the second side portion 570c in the first direction X. Accordingly, as illustrated in FIG. 11, a part of the upper surface of the first side portion 570b may be covered by the third side portion 570d and a first surface S1 which is the remaining part may be exposed. In a similar way, a part of the upper surface of the second side portion 570c may be covered by the fourth side portion 570e and a second surface S2 which is the remaining part may be exposed.

Therefore, an end of the optical sheet 120 disposed on the first light source unit 110 is in contact with the exposed first surface S1 of the upper surface of the first side portion 570b of the cover 570 to be supported by the first side portion 570b and the other end of the optical sheet 120 is in contact with the exposed second surface S2 of the upper surface of the second side portion 570c of the cover 570 to be supported by the second side portion 570c.

Further, the third side portion 570d and the fourth side portion 570e of the cover 570 may have the same height. For example, a height of the third side portion 570d in the third direction Z may be equal to a height of the fourth side portion 570e in the third direction Z.

The first fixing member 580 may be disposed above one end of the optical sheet 120 and the second fixing member 590 may be disposed above the other end of the optical sheet 120.

A height of the first fixing member 580 may be different from a height of the second fixing member 590. For example, a height of the first fixing member 580 in the third direction Z may be larger than a height of the second fixing member 590 in the third direction Z.

The light controller 530 is disposed on the optical sheet 120 and both ends are in contact with the first fixing member 580 and the second fixing member 590 to be supported by the first fixing member 580 and the second fixing member 590. For example, one end of the light controller 530 is in contact with the first fixing member 580 to be supported by the first fixing member 580 and the other end of the light controller 530 is in contact with the second fixing member 590 to be supported by the second fixing member 590.

Here, the light controller 530 may be formed to be inclined by a predetermined tilt angle, by the height difference of the first fixing member 580 and the second fixing member 590.

To be more specific, further referring to FIG. 12, the light controller 530 may be formed to be inclined to the first direction X by a predetermined tilt angle TAG, by the height difference of the first fixing member 580 and the second fixing member 590. For example, the light controller 530 may be formed so as to be rotated by the tilt angle TAG in the clockwise direction on the plane defined by the first direction X and the third direction Z.

Therefore, all the first support member 531, the second support member 532, and the plurality of partitions 533 disposed between the first support member 531 and the second support member 532 included in the light controller 530 may be formed so as to be inclined to the first direction X by the predetermined tilt angle TAG, for example, so as to rotate by the tilt angle TAG in the clockwise direction, on the plane defined by the first direction X and the third direction Z. For example, the light controller 530, for example, the first support member 531 and/or the second support member 532 is formed to rotate by the tilt angle TAG in the clockwise direction, on the plane defined by the first direction X and the third direction Z with respect to a first reference line RL1 parallel to the first direction X. Therefore, a center axis CX of the plurality of partitions 533 formed between the first support member 531 and the second support member 532 may be formed to rotate by the tilt angle TAG in the clockwise direction, on the plane defined by the first direction X and the third direction Z with respect to a second reference line RL2 parallel to the third direction Z.

In this case, when light provided from the bottom of the light controller 530, for example, light provided from the first light source unit 110 is emitted from the light controller 530 via the light controller 530, the light may be shifted to the first direction X by the plurality of partitions 533, which are formed to be inclined by the predetermined tilt angle TAG. For example, the plurality of partitions 533 disposed on the second area A2 are inclined to the first direction X so that sixth light L6 emitted from the light controller 530 in the second area A2 may be totally shifted to the first direction X. Accordingly, in the case of the image which is displayed on the second area A2 by the light provided from the first light source unit 110, a viewing angle to the first area A1 may be more effectively restricted.

As described above, the plurality of partitions 533 disposed on the first area A1 have a very small height so that seven lights L7 emitted from the light controller 530 in the first area A1 may be emitted with an emission angle which is not substantially restricted.

The tilt angle TAG may be determined depending on a degree of shifting light emitted from the light controller 530 in the second area A2 to the first direction X by the plurality of partitions 533 disposed on the second area A2.

Even though in FIGS. 11 and 12, it has been described that the entire light controller 530 is inclined to the first direction X by the predetermined tilt angle TAG, only a part of the light controller 530 may be formed to be inclined to the first direction X by the predetermined angle TAG. To be more specific, the light controller may be formed to be inclined to the first direction X by the tilt angle TAG on a boundary line BL between the first area A1 and the second area A2. For example, an area of the light controller 530 corresponding to the first area A1 is formed to be horizontal and an area which is inclined to the first direction X by the tilt angle TAG from the boundary line BL to correspond to the second area A2 may be formed to be inclined to the first direction X. Referring to FIG. 11 again, the fifth side portion 570f of the cover 570 may be disposed above the third side portion 570d and the sixth side portion 570g of the cover 570 may be disposed above the fourth side portion 570e. For example, the fifth side portion 570f of the cover 570 may be in contact with an upper surface of the third side portion 570d and the sixth side portion 570g of the cover 570 may be in contact with an upper surface of the fourth side portion 570e. In the meantime, as described above, the fifth side portion 570f and the sixth side portion 570g may be integrally formed with the third side portion 570d and the fourth side portion 570e.

The fifth side portion 570f and the sixth side portion 570g of the cover 570 may have the same width. For example, a width of the fifth side portion 570f in the first direction X and a width of the sixth side portion 570g in the first direction X may be equal.

Widths of the fifth side portion 570f and the sixth side portion 570g of the cover 570 in the first direction X may be less than the widths of the third side portion 570d and the fourth side portion 570e in the first direction X. Accordingly, as illustrated in FIG. 11, a part of the upper surface of the third side portion 570d may be covered by the fifth side portion 570f and a third surface S3 which is the remaining part may be exposed. In a similar way, a part of the upper surface of the fourth side portion 570e may be covered by the sixth side portion 570g and a fourth surface S4 which is the remaining part may be exposed.

Therefore, an end of the light guide plate 150 disposed on the light controller 530 is in contact with the exposed third surface S3 of the upper surface of the third side portion 570d of the cover 570 to be supported by the third side portion 570d and the other end of the light guide plate 150 is in contact with the exposed fourth surface S4 of the upper surface of the fourth side portion 570e of the cover 570 to be supported by the fourth side portion 570e.

Further, the fifth side portion 570f and the sixth side portion 570g of the cover 570 may have the same height. For example, a height of the fifth side portion 570f in the third direction Z and a height of the sixth side portion 570g in the third direction Z may be equal.

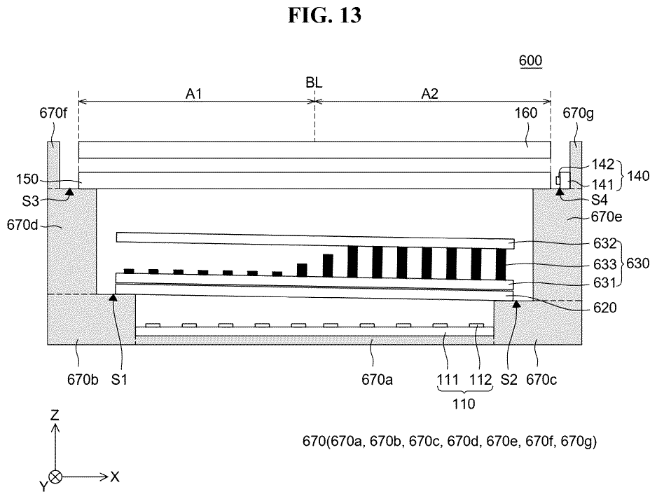

FIG. 13 is a side view of a display device according to still another embodiment of the invention.

In the meantime, a display device 600 of FIG. 13 is a modified embodiment of the display device 500 which has been described with reference to FIGS. 11 and 12, with regard to a shape of the cover 670. Accordingly, in FIG. 13, in order to avoid a redundant description, differences from the above-described embodiments will be mainly described.

FIG. 13 illustrates that a shape of a plurality of partitions 633 included in the light controller 630 is substantially the same as or similar to the shape of the partition 133 which has been described with reference to FIGS. 4 to 5C, but this is merely illustrative and the inventive concepts are not limited thereto. For example, the plurality of partitions 633 included in the light controller 630 may have a shape of the partitions 233, 333, and 433 according to any one embodiment, among a shape of the partition 233 which has been described with reference to FIGS. 6 to 7B, a shape of the partition 333 which has been described with reference to FIGS. 8 and 9, or a shape of the partition 433 which has been described with reference to FIG. 10.

Referring to FIG. 13, the display device 600 according to still another embodiment of the invention may include a first light source unit 110, at least one optical sheet 620, a light controller 630, a second light source unit 140, a light guide plate 150, a display panel 160, and a cover 670.

The cover 670 is an external cover of the display device 600 and may support or accommodate various configurations of the display device 600, for example, the first light source unit 110, at least one optical sheet 620, the light controller 630, the second light source unit 140, the light guide plate 150, and the display panel 160. For example, the cover 670 may be a housing.

To this end, the cover 670 has a top-open shape and may include a bottom portion 670a, a first side portion 670b, a second side portion 670c, a third side portion 670d, a fourth side portion 670e, a fifth side portion 670f, and a sixth side portion 670g. In the meantime, the bottom portion 670a, the first side portion 670b, the second side portion 670c, the third side portion 670d, the fourth side portion 670e, the fifth side portion 670f, and the sixth side portion 670g are integrally formed to configure the cover 670. Therefore, in this way, the cover 670 is divided into regions based on a plane, for example, a plane defined by the first direction X and the third direction Z and this is merely illustrative for the convenience of explanation, and the cover 670 may be divided in various ways.

The bottom portion 670a of the cover 670 is disposed on the lowermost portion of the display device 600 to support the first light source unit 110.

The first side portion 670b and the second side portion 670c of the cover 670 are disposed on both sides of the bottom portion 670a to be in contact with both ends of the bottom portion 670a. Further, as described with reference to FIG. 11, the first side portion 670b and the second side portion 670c of the cover 670 may have the same width.

The first side portion 670b and the second side portion 670c of the cover 670 may have different heights. For example, a height of the first side portion 670b in the third direction Z may be greater than a height of the second side portion 670c in the third direction Z.

The third side portion 670d of the cover 670 may be disposed above the first side portion 670b and the fourth side portion 670e of the cover 670 may be disposed above the second side portion 670c. Further, as described with reference to FIG. 11, the third side portion 670d and the fourth side portion 670e of the cover 670 may have the same width.

Widths of the third side portion 670d and the fourth side portion 670e of the cover 670 in the first direction X may be smaller than the widths of the first side portion 670b and the second side portion 670c in the first direction X. Accordingly, as illustrated in FIG. 13, a part of the upper surface of the first side portion 670b may be covered by the third side portion 670d and a first surface S1 which is the remaining part may be exposed. In the similar way, a part of the upper surface of the second side portion 670c may be covered by the fourth side portion 670e and a second surface S2 which is the remaining part may be exposed.

Therefore, an end of the optical sheet 620 disposed on the first light source unit 110 is in contact with the exposed first surface S1 of the upper surface of the first side portion 670b of the cover 670 to be supported by the first side portion 670b and the other end of the optical sheet 620 is in contact with the exposed second surface S2 of the upper surface of the second side portion 670c of the cover 670 to be supported by the second side portion 670c.

Here, the optical sheet 620 may be formed to be inclined by a predetermined tilt angle TAG by the height difference of the first side portion 670b and the second side portion 670c of the cover 670.

Further, the light controller 630 may be disposed on the optical sheet 620. At this time, the optical sheet 620 disposed below the light controller is formed to be inclined by a predetermined tilt angle TAG so that the light controller 630 may also be formed to be inclined by the predetermined tilt angle TAG. Accordingly, when light provided from the bottom of the light controller 630, for example, light provided from the first light source unit 110 is emitted from the light controller 630 via the light controller 630, the light may be shifted to the first direction X by the plurality of partitions 633 which is formed to be inclined by the predetermined tilt angle TAG. For example, the plurality of partitions 633 disposed on the second area A2 is inclined to the first direction X so that light emitted from the light controller 630 in the second area A2 may be totally shifted to the first direction X. Accordingly, in the case of the image which is displayed on the second area A2 by the light provided from the first light source unit 110, a viewing angle to the first area A1 may be more effectively restricted.

Even though in FIG. 13, it has been described that the optical sheet 620 and the light controller 630 are entirely inclined to the first direction X by the predetermined tilt angle TAG, only a part of the optical sheet 620 and the light controller 630 may be formed to be inclined to the first direction X by the predetermined angle TAG. To be more specific, the optical sheet and the light controller may be formed to be inclined to the first direction X by the tilt angle TAG on a boundary line BL between the first area A1 and the second area A2. For example, an area of the optical sheet 620 and the light controller 630 corresponding to the first area A1 is formed to be horizontal and an area which is inclined to the first direction X by the tilt angle TAG from the boundary line BL to correspond to the second area A2 may be formed to be inclined to the first direction X. Further, the third side portion 670d and the fourth side portion 670e of the cover 670 may have the same height. For example, a height of the third side portion 670d in the third direction Z and a height of the fourth side portion 670e in the third direction Z may be equal.

The fifth side portion 670f of the cover 670 may be disposed above the third side portion 670d and the sixth side portion 670g of the cover 670 may be disposed above the fourth side portion 670e. Further, as described with reference to FIG. 11, the fifth side portion 670f and the sixth side portion 670g of the cover 670 may have the same width and the same height.

Widths of the fifth side portion 670f and the sixth side portion 670g of the cover 670 in the first direction X may be smaller than the widths of the third side portion 670d and the fourth side portion 670e in the first direction X. Accordingly, as illustrated in FIG. 13, a part of the upper surface of the third side portion 670d may be covered by the fifth side portion 670f and a third surface S3 which is the remaining part may be exposed. In the similar way, a part of the upper surface of the fourth side portion 670e may be covered by the sixth side portion 670g and a fourth surface S4 which is the remaining part may be exposed.

Therefore, an end of the light guide plate 150 disposed on the light controller 630 is in contact with the exposed third surface S3 of the upper surface of the third side portion 670d of the cover 670 to be supported by the third side portion 670d and the other end of the light guide plate 150 is in contact with the exposed fourth surface S4 of the upper surface of the fourth side portion 670e of the cover 670 to be supported by the fourth side portion 670e.

According to embodiments of the invention, some of a plurality of light source units disposed below a display panel are controlled to emit light according to a driving mode to control both a first area and a second area as a wide field-of-view mode in a first mode and control a first area as a wide field-of-view mode and a second area as a narrow field-of-view mode in a second mode.

According to embodiments of the invention, light provided to the display panel is shifted toward the second area so as not to allow an image displayed in the second area to be visible to a user located in the first area, thereby effectively controlling the viewing angle in the second mode.

According to embodiments of the invention, a height of a partition which controls a viewing angle in each area is designed to be gradually changed around a boundary line between a first area and a second area, thereby minimizing a boundary visibility between the first area and the second area.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. A display device, comprising:
a first light source unit including a plurality of first light sources;
a light controller disposed on the first light source unit and;
a second light source unit disposed on the light controller and including a plurality of second light sources;
a light guide plate disposed parallel to the second light source unit and configured to guide light provided from the second light source unit; and
a display panel disposed on the light guide plate, the display panel comprising an active area and configured to display an image using light provided from the first light source unit or the second light source unit,
wherein the light controller includes a plurality of partitions overlapping at least a partial area of the active area, and the plurality of partitions are separated from each other and have different heights in each area.

2. The display device of claim 1, wherein the active area includes:
a first area in which an image is displayed at a first viewing angle in a first mode and a second mode; and
a second area in which an image is displayed at the first viewing angle in the first mode and an image is displayed at a second viewing angle which is smaller than the first viewing angle in the second mode.

3. The display device of claim 2, wherein heights of the plurality of partitions are decreased from the second area toward the first area.

4. The display device of claim 2, wherein the plurality of partitions includes:
a plurality of first partitions having a first height, the plurality of first partitions being disposed on a first sub area, which is a partial area of the first area;
a plurality of second partitions having a second height greater than the first height, the plurality of partitions being disposed on a second sub area, which is a partial area of the second area; and
a plurality of third partitions disposed on a third sub area between the first sub area and the second sub area and having a height between the first height and the second height.

5. The display device of claim 4, wherein the height of each of the plurality of third partitions is decreased from the second sub area toward the first sub area.

6. The display device of claim 4, wherein the third sub area includes a boundary line between the first area and the second area.

7. The display device of claim 1, wherein each of the plurality of partitions has a quadrangular columnar shape.

8. The display device of claim 7, wherein each of the plurality of partitions has a rectangular or trapezoidal side surface.

9. The display device of claim 1, wherein a center axis of each of the plurality of partitions is inclined from a direction perpendicular to the active area.

10. A display device, comprising:
a cover;
a first light source unit disposed on a bottom portion of the cover and including a plurality of first light sources;
an optical sheet disposed on the first light source unit and having one end supported by a first side portion of the cover and the other end supported by a second side portion of the cover;
a first fixing member disposed above the one end of the optical sheet;
a second fixing member disposed above the other end of the optical sheet;
a light controller disposed on the optical sheet and having one end supported by the first fixing member and the other end supported by the second fixing member;
a light guide plate disposed on the light controller and having one end supported by a third side portion of the cover and the other end supported by a fourth side portion of the cover;
a second light source unit disposed to be parallel to the light guide plate and including a plurality of second light sources; and
a display panel disposed on the light guide plate, the display panel comprising an active area and configured to display an image using light provided from the first light source unit or the second light source unit.

11. The display device of claim 10, wherein a height of the first fixing member is different from a height of the second fixing member.

12. The display device of claim 10, wherein:
the first side portion and the second side portion are disposed on the same plane;
the third side portion is disposed on the first side portion; and
the fourth side portion is disposed on the second side portion and is disposed on the same plane as the third side portion.

13. The display device of claim 10, wherein the light controller is inclined from a direction parallel to the active area.

14. A display device comprising:
a cover;
a first light source unit disposed on a bottom portion of the cover and including a plurality of first light sources;
an optical sheet disposed on the first light source unit and having one end supported by a first side portion of the cover and the other end supported by a second side portion of the cover;
a light controller disposed on the optical sheet;
a light guide plate disposed on the light controller and having one end supported by a third side portion of the cover and the other end supported by a fourth side portion of the cover;
a second light source unit disposed to be parallel to the light guide plate and including a plurality of second light sources; and
a display panel disposed on the light guide plate, the display panel comprising an active area and configured to display an image using light provided from the first light source unit or the second light source unit,
wherein:
the light controller includes a plurality of partitions overlapping at least a partial area of the active area, and the plurality of partitions are separated from each other and have different heights; and
a height from the bottom portion of the cover to a top surface of the first side portion is different from a height from the bottom portion of the cover to the second side portion.

15. The display device of claim 14, wherein the optical sheet and the light controller are inclined from a direction parallel to the active area.

16. The display device of claim 1, further comprising an optical sheet between the first light source unit and the light controller.

17. The display device of claim 2, wherein the second area is adjacent to the first area.
